(19) United States
(12) Patent Application Publication
(10) Pub. No.: US 2008/0100851 A1
(43) Pub. Date: May 1, 2008

(54) Laser array

(76) Inventors: Jean-Michel Asfour, Weinheim (DE); Hans-Peter Haar, Wiesloch (DE); Rudolf Pachl, Ellerstadt (DE); Peter Seelig, Frankfurt am Main (DE); Bernd Stenkamp, Danville, CA (US); Volker Zimmer, Laumersheim (DE)

Correspondence Address: BOSE MCKINNEY & EVANS LLP, 2700 FIRST INDIANA PLAZA, 135 NORTH PENNSYLVANIA STREET, INDIANAPOLIS, IN, 46204, US

(21) Appl. No.: 11/784,684

(22) Filed: Apr. 9, 2007

(30) Foreign Application Priority Data
Apr. 8, 2006 (EP) EP06007460.6

(51) Int. Cl. G01B 11/24

(52) U.S. Cl. 356/601

(57) ABSTRACT

A system and method for the optical determination of the concentration of an analyte in a body fluid. The system comprises an analytical test element which has a support layer and a detection area arranged thereon which contains the reagents required for the detection of the analyte in a body fluid as well as an instrument which has an illumination unit with at least one light source, a detection unit and an evaluation unit. The detection unit is optically scanned with the illumination unit and the detection unit.

### RELATED APPLICATIONS

This application claims priority to European Patent Application No. 06007460.6, filed Apr. 8, 2006, which is hereby incorporated by reference.

### BACKGROUND AND SUMMARY

The present invention relates to determining concentration of an analyte in a liquid.

The determination of the concentration of various analytes in physiological samples is of growing importance in our society. Such samples are examined in various fields of application, e.g., in clinical laboratories and in home-monitoring.

The results of these examinations are of major importance for managing various diseases. They include above all glucose measurements for diabetes management and cholesterol measurements for cardiac and vascular diseases. Medical blood diagnostics requires the collection of a blood sample from the individual to be examined.

The analysis performed after the lancing process is often carried out in a small portable measuring device, a so-called handheld device, in which the test elements wetted with blood are analyzed. These handheld devices are of major importance especially in the diagnosis of diabetes diseases. The measurement in these devices is typically carried out electrochemically or optically. In the case of optically-based measurements, the sample is illuminated with light and the reflected light is detected in order to determine analyte concentration. Test elements, such as test strips, are normally used for this, which are wetted with the sample such as blood or interstitial fluid. The sample subsequently reacts with the reagents that are applied to this test element. This may lead to a change in color or to changes in charge or current in the case of an electrochemical reaction which can then be detected.

When using these test elements it is very important that the detection area of the test element is uniformly wetted with the test liquid. Inhomogeneous or inadequate wetting of the detection area can result in erroneous results. Especially when a small amount of test liquid is used, the distribution on the test element may be non-uniform or only a part of the detection area may be wetted with sample material. In conventional, optically-based measurement methods, the light reflected from small sections of this detection area is measured. If the detection area has been inadequately wetted, it may fall short of the size of the measured section required for an error-free measurement. This often leads to an inaccurate measurement, and for the patient this means either a repeat measurement or false measured values.

One approach to solving these problems is described in U.S. Pat. No. 5,889,585, U.S. Pat. No. 6,055,060 and Patent Publication No. WO 97/36168. In this approach, a spatially resolved measurement is carried out in which two different points on the test element are illuminated and a ratio of the two measured results is formed in order to detect a possible non-uniform wetting. If an inhomogeneous wetting is detected, the user is prompted to apply more sample to the test element.

A disadvantage of this method is that small sample volumes cannot be measured because a sufficiently large sample volume for a complete wetting is not available.

The invention EP 1 359 409 A2 describes a method for distinguishing between wetted and unwetted areas on the test element in order to analyze small sample volumes which do not completely wet the test field. One to two light sources are used for this which illuminate the test element and are detected by means of a detector array. The areas that have been slightly wetted or not wetted at all are not used for the analysis.

A disadvantage of this invention is that no further differentiation of the wetted areas is carried out. However, if the test element is partially wetted, the sample is dispersed non-uniformly on the test element. The edge area has a different average analyte concentration than the core of the sample drop. This is due to different spreading potentials and thus also to different diffusion processes of the liquid in the core and in the edge area. However, no differentiation is made between the edge area and wetted areas in European Application No. EP 1 359 409 A2 and thus the edge areas are analyzed in the same manner as the core of the sample drop.

Furthermore, quality control of the test element does not take place in the wetted nor in the unwetted subareas. The undifferentiated analysis and the lack of quality control can result in a large error in the measured result in the case of small sample volumes.

Since the trend is towards more highly automated and integrated systems for less painful blood collection and detection, which can only be achieved by smaller puncture depths that produce smaller amounts of blood, a reliable measurement of minimal volumes of blood is essential.

The measuring devices that are described in the art suffer from the drawback that it is not possible to carry out a differentiated analysis of the measured signals that are irradiated from different areas of the wetted test element. In the case of very small sample volumes, where the edge area constitutes a large proportion of the sample drop on the test element, a differentiation of the wetted subareas is, however, essential in order to carry out a sufficiently accurate determination of the analyte. Furthermore, it is necessary to ensure a sufficiently homogeneous sample distribution in the case of small volumes of sample. An inhomogeneous test element would prevent this and the faults in the test element could also lead to inaccurate measurements.

Such a quality control of the test elements before or after application of the blood sample is not described in the prior art. As a result, measurements are also accepted which have been calculated from erroneous signals. Another source of errors for false measuring results is the different dispersion of the blood sample on the detection area of the test element. The dispersion, also referred to as spreading, depends on the viscosity of the blood. The composition of the blood influences spreading as does the surface on which the blood spreads. As described above, the sample drop forms an edge area on the test element which has a different average analyte concentration compared to the core of the drop. By detecting and correcting these differences, it is, for example, possible to reduce the risk to a diabetes patient of using false glucose values as the basis for a subsequent insulin therapy.

For these reasons there is much interest in the development of new devices and methods which give a satisfactory test result even with very small amounts of sample liquid. This requires a system which also allows analyses of the drop in the edge areas. This would almost exclude additional measurements due to inadequate volumes of sample that would necessitate an additional lancing and thus additional pain and costs. The advantage to the patient is that due to the minimal volumes of sample that are required for the measurement, it is possible to generate the necessary amount of blood in a less painful manner. Less lancing pain would increase the willingness of the patient to measure the blood glucose value frequently and thus achieve better control of blood glucose level.

Hence, embodiments disclosed herein provide an analytical system which can measure very small volumes of sample in a differentiated and exact manner without the patient running the risk of basing his subsequent therapy on erroneous measurements. The system also provides for quality control of the measurement.

A system is described herein for detecting an analyte in body fluids. An analytical test element which has a support layer and a detection area arranged thereon can be used in the system. If necessary, the detection area comprises reagents which react with the analyte. The system additionally comprises an instrument which has an illumination unit, a detection unit and an evaluation unit, where the evaluation unit can be integrated in the detection unit. The illumination unit can be composed of a laser diode, a laser, a laser array, a laser diode array or another light source that can be readily focused. Light focused by the illumination unit onto the detection area is partially absorbed by the test element and partially reflected or transmitted. Irrespective of whether reflected or transmitted light is measured, the light emitted by the detection area is captured by a detection unit and the detected signal is transmitted to the evaluation unit.

The evaluation unit is programmed such that the intensities of the illuminated or detected subareas are compared with at least one threshold value. If the intensity exceeds or falls below a certain value, in this case the first threshold value, that part of the detection area is determined to be wetted. If the intensity of a subarea also exceeds or falls below a second threshold value, this subarea is allocated to the core area of the sample drop. Subareas which only exceed or fall below the first but not the second threshold value are allocated to the edge area.

The test element (which is stored dry) is wetted by the test liquid (e.g., blood, interstitial fluid, urine or other body fluids) when used and in this process a reaction with the reagents on the test element can be triggered if reagents are present. If special excitation or detection systems are used no reagents are necessary in this area. A reagent-free measurement can for example be based on the determination of the optical refractive index or on an IR-spectroscopic measurement. Then the concentration of the analyte is determined directly without a reactive conversion.

In the case of large sample volumes, the edge area is very small compared to the core area and a separate evaluation can be neglected. In this case, the evaluation is carried out with the aid of an algorithm which correlates the intensities of the subareas to a concentration value of the analyte. This correlation between intensity and concentration can be stored in a table.

If small volumes of sample are used, the detection area of the test element becomes only partially wetted. In this case the wetted area is also referred to as the sample drop. When evaluating the sample drop, only the sections which have been adequately wetted with body fluid are taken into account to determine the concentration of the analyte. This differentiation of wetted and unwetted areas is carried out as already described with the aid of the first threshold value for the measured light intensity of the individual subareas. The partial wetting leads to the formation of edge areas on the detection area because the sample and thus also the analyte are distributed differently at the edge of the applied drop than in the core of the drop. The exchange of liquid and thus also of analyte in these areas is different since in the edge area the sample borders unwetted subareas. Thus, a concentration gradient from wetted to unwetted subareas occurs in the edge area, whereas the subareas in the core of the drop border subareas which on average have the same amounts of liquid and thus analyte concentration. The distribution of the sample liquid depends on the viscosity and composition of the sample as well as on the properties of the detection area. Especially in the case of small volumes of sample, a separate evaluation of the edge area can lead to more accurate results. If the proportion of the edge area exceeds about 50%, the measurement result can be falsified by more than, e.g., 10% depending on the content of analyte if all wetted subareas are averaged.

In order to avoid this falsification, the signals of the subareas of the edge area which lie between the unwetted or not adequately wetted areas and the subareas of the core area are evaluated with the aid of a correction algorithm. The different evaluation of the edge and core areas enables an exact evaluation of very small sample volumes (<100 nl). This means that test elements can be used which have a smaller detection area than is the case for conventional test elements. Consequently, the area of the detection area of the test element can be reduced, thus requiring a smaller amount of light to illuminate it. Hence, the energy requirement of the system can be lowered and the system can be further miniaturized.

An evaporation process may start after application of the liquid, depending on the structure of the detection area. This evaporation process dries the sample drop starting from the edge. During this drying process, the analyte can be concentrated in the edge region. On the other hand, if this drying process does not occur because the test element has a multilayer structure, and evaporation of liquid is negligible within the time frame of the measurement (seconds), the analyte can be concentrated in the core of the sample drop. Both effects can result in significant shifts in the measurement signals in the core area of the sample drop, especially with very small amounts of sample in which the edge area constitutes a larger proportion of the sample drop than is the case with large amounts of sample. If only the intensities from the core area were evaluated, an erroneously low concentration would be determined if the analyte were concentrated in the edge area. Similarly, the concentration determined would be too high if the analyte were concentrated in the core area. One system is described herein in which the wetted subareas are darkened due to the reaction of the analyte with the reagent and the associated color formation. In addition, this system typically has less analyte in the edge area.

However, systems are also encompassed by these teachings in which the intensity increases when the analyte reacts with the reagent as well as systems in which analyte is concentrated in the edge area.

For simplicity, the terminology “meet” or “fail to meet” the threshold is also used herein to cover situations in which the measured light intensity parameter falls below the numerical value of the threshold value or exceeds the numerical value of the threshold value, depending upon what is appropriate for the particular situation. For example, as just noted, in one system described herein, the wetted subareas are darkened due to the reaction of the analyte. In this case, the darkest areas are adequately wetted, in which event reflectance values that fall below the threshold value meet the threshold. In the case of fluoroscopic measurements, as also discussed below, the opposite is true, such that intensity values that fall below the threshold value fail to meet the threshold.

Use of two threshold values allows a differentiated evaluation of the sample drop in the edge and core areas. By using different algorithms or using correction factors for these subareas, it is possible to more accurately quantify analyte concentration compared to conventional averaging methods. The correction algorithm can be a multi-step correction based on a table that includes correction factors of different magnitudes for various intensity ranges. If the signals are outside of the correctable range or the quality control indicates that the measurement is not suitable, the patient can be made aware that the result of the measurement may be erroneous by a warning signal (e.g., optical or acoustic). In addition, the patient can be prompted to repeat the measurement.

In addition to the differentiated evaluation of the edge and core areas, for a more accurate determination of analyte concentration, the shape and extent of the edge area can additionally be used for quality control. If the extent of the edge area exceeds or falls below, for example, a preset value, then this finding can be used for quality control. The shape and extent of the edge area which deviates from the norm is influenced by the following boundary conditions:
irregularities in the detection area which can arise during manufacture
contamination of the detection area before or during use
sample properties which deviate from the norm, such as viscosity changes, e.g., by changes in the hematocrit content or other blood components.

These irregularities and contamination of the detection area can be detected before or after application of the sample, and can be used for quality control. If such irregularities or contamination are found, the patient can be prompted to use a new test element. The irregularities of the detection area often may not be visible to the patient because they are either too small to be visually detected or because they are in a layer of the detection area which is covered by the uppermost layer. There may be defective sites in one or more layers or the reagents may be distributed inhomogeneously if they are required to detect the analyte. These irregularities can have the effect that the drop does not spread uniformly on the detection area, but instead forms edge areas which deviate from the norm at at least one site or location. Thus, for example, a discontinuity of the edge area around the drop can be an indication for such an irregularity. Contamination of the detection area may also not be visible to the patient and can have the same consequences for the spreading of the sample drop on the detection area as the manufacturing-related changes.

The sample properties resulting from the composition of the sample (usually blood) can vary widely. The composition of the sample has a major influence on the viscosity of the sample and thus on the spreading of the sample drop on the detection area. One of the main factors which affects the viscosity of the sample is the hematocrit content of the blood. Even within the normal range (35-55% of the blood volume) the edge area may be more or less pronounced which, however, can be compensated by the correction algorithm. If one or more blood parameters deviate significantly from the norm, this may affect the viscosity and thus the spreading of the sample on the detection area. A dimension interval or size for the edge area can be defined in order to identify such samples which exceed or fall short of the defined interval. This ensures a sufficiently accurate evaluation of the measurement.

The area of the edge area can be determined by knowing the number of subareas which lie between the first and the second threshold value and the area of each subarea. Then, if the surface area of the edge area as a proportion of the total surface area of the wetted subareas exceeds or falls below a dimension interval (defined threshold value) which depends on the size of the surface area of the wetted subareas, the measurement can be terminated. In this case it must be assumed that there is a fault which cannot be compensated with a correction algorithm. This may be caused by interferences in the sample as well as in or on the detection area. One reason an edge/core area ratio may be too low is that a discontinuity exists in the edge area around the core area. For this purpose, it is determined whether all subareas of the core area adjoin an unwetted subarea. The number of subareas which directly adjoin unwetted subareas is expressed as a ratio to the total number of subareas of the core area. If this ratio exceeds a ratio threshold, the measurement can be terminated, since it must be assumed that there is a faulty site in the detection area. In an exemplary embodiment, the measurement is terminated when more than 10% of the subareas of the core area are not surrounded by an edge area but rather by unwetted subareas.

If the edge area exceeds a maximum width at at least some sites, the measurement can also be terminated. In this evaluation, one determines whether each subarea which is determined to be a core area, and adjoins a subarea which is determined to be an edge area, exceeds a maximum distance to the furthest removed unwetted subarea. In other words, the maximum edge width is determined from each core subarea that borders an edge subarea. Only subareas from the edge area may lie on the path between the wetted and unwetted subarea. The measurement can be terminated when the maximum distance exceeds an outer edge area threshold value. In this connection the outer edge area threshold value can be defined as a function of the test element that is used.

Furthermore, an edge area that is too narrow can result in non-rectifiable changes in the detection area or sample. Similar to the evaluation just discussed, an edge area that is too narrow can be ascertained by determining a minimum distance to the nearest unwetted subarea for each core subarea which adjoins an edge subarea, where only subareas from the edge area lie on the path between the wetted and unwetted subarea. The measurement can be terminated when the minimum distance falls below an inner edge area threshold value and/or the maximum distance exceeds an outer edge area threshold value.

A further quality control can be carried out by calculating the gradient or the distribution of the intensities in the edge area. In the case of a normal distribution of the components of the sample, the intensity gradient of the edge area has a characteristic shape. One method of determining this changed gradient is to determine the slope of the measured values from the inner to the outer region of the edge area. The inner region of the edge area borders on a subarea of the core area and the outer region of the edge area borders on unwetted subareas. The slope is determined by determining the change in intensity of neighboring pixels. If the slope exceeds or falls below a specified normal range, a correction algorithm is used in each case to account for the decreased or increased viscosity of the blood. In one embodiment, the deviation of the slope from the normal value should not fall below or exceed 20%. Depending on the spreading net used in the test element, the normal range can be between 10 and 40 μm. In an exemplary embodiment it is between 20 and 30 μm. If the dimensions of the edge area deviate between 1 and 20% from the normal range, then the correction algorithm can be used which takes into account the extent of the deviation from the normal range. The correction algorithm can, for example, be a table containing correction factors which is either permanently incorporated into the detection unit or into the evaluation unit. A correction can be made or adapted with the aid of a table using code information. If the edge area deviates by more than 20% from the lower or upper normal range, the measurement can be discarded because it must be assumed that contamination or defects in the test element are present.

If the edge area is in a specified normal range, it is possible to measure very small amounts of sample with the aid of the correction algorithm, which would be highly inaccurate without this algorithm. This is particularly important for very low analyte concentrations, because, for example, when determining low glucose concentrations of a diabetic, the erroneous measurement could have serious consequences (such as loss of consciousness or even death). A multistep hematocrit content estimation can be carried out by selecting the correction factor from the table deposited in the evaluation unit. These correction algorithms which evaluate the edge areas enable the analysis of a volume down to 10 nl on the detection area. This approximately corresponds to a blood volume of less than 50 nl, which is a considerable reduction of the blood volume for glucose determination compared to prior art systems.

The detection can be designed to be spatially resolved with the aid of pixel detectors. In this case the intensity detected by each pixel corresponds to the site of a subarea on the detection area. The intensity of the light emitted from the subarea can be stored along with the position of the subarea. This spatially resolved measurement of the detection area is referred to as a system of the first type. Furthermore, the illumination can also be designed such that only a small section or subarea of sample on the test element is illuminated, the position and size of which is known. The intensity of each subarea on the detection area can be stored and processed together with its spatial information. Storage of spatial information is only necessary for one variant of edge area evaluation. Systems which ensure a spatially resolved measurement with the aid of several light sources are referred to as systems of the second type. With a system of the first as well as of the second type it is possible to carry out a spatially resolved measurement which can achieve a comparable resolution of the detection area.

The system of the first type can use one or more light sources to adequately illuminate the test element and evaluates the light intensities emitted from the detection area with the aid of a spatially resolved detection unit. A scattering medium, e.g., a lens, can be arranged between the light source and detection area for a homogeneous illumination of the detection area. The scattering medium diffusely scatters the light of the light source and thus reduces differences in intensity of the irradiated light on the detection area. Photodiode arrays (silicon), line arrays, camera chips, CCD cameras or CMOS chips can, among others, be used as detectors.

In the system of the second type at least one light source is required for the sequential illumination of the detection area. The illuminating optics can consist of a semiconductor laser unit in which a laser beam is emitted perpendicular to the assembly plane. Alternatively it is also possible to use conventional light sources with an appropriate filtering or also LEDs (light emitting diodes) or LED arrays. Both systems of spatially resolved irradiation and spatially resolved detection can be combined with one another.

Depending on whether the measurement is an absorption of light or a fluorescence measurement, wetted subareas will fall below or exceed the first threshold value. An absorption measurement is used herein as an example in which the wetted subareas fall below the first threshold value. In the case of an absorption measurement a color is formed during the reaction of the analyte with the reagent which absorbs light of the irradiated wavelength. This leads to a darkening of the detection area. Hence the wetted subareas emit less light and have a lower reflectance than the unwetted subareas. In the case of a fluorescence measurement a fluorescent dye is, for example, formed or bound when the analyte is present in the sample and the dye emits light of a certain wavelength to be detected or quenches another dye or a mutual quenching takes place. In this case the wetted subareas containing analyte can have a higher intensity at the detected wavelength than the unwetted subareas, but they can also have lower intensities.

The sample volume of the body fluid for determining the concentration of the analyte can be less than 1 μl. A preferred range of sample volume is between 10 and 500 nl, which can still be measured with sufficient accuracy. In this case, the measurement time for determining the concentration can be less than 5 seconds. The structure of test elements for small sample volumes can in principle be based on known structure of test elements such as those disclosed in US 2005/0201897, U.S. Pat. No. 6,881,378, U.S. Pat. No. 6,696,024, U.S. Pat. No. 6,592,815, U.S. Pat. No. 5,814,522, U.S. Pat. No. 5,451,350, EP 1 035 920 or EP 1 035 921.

Furthermore, these teachings disclose an instrument suitable for use in the system. This instrument can additionally have a scattering medium between the light source and detection area in order to homogeneously illuminate the detection area.

In addition, these teachings disclose use of a lighting array in the system for determining the concentration of an analyte. In this case, subareas of the detection area of a test element are sequentially or simultaneously illuminated by at least one light source. Furthermore, the radiation emitted by the test element is detected by a detector and the detector data are evaluated and the signals of the subareas are compared with at least two threshold values. The subareas are illuminated with a lighting array comprising at least two light sources.

In addition, the applied volume can be calculated in the evaluation unit. This volume calculation is, for example, made possible by a net structure (such as a spreading net). The wetted surface area of the detection area can be determined with the aid of this net structure which has a grid structure having a known grid spacing. A sample volume can be deduced from the number of wetted subareas of the detection area on the grid structure. The smallest amounts of sample that can be determined are, for example, in the range of 10 nl. In this case, the measuring time can be less than 5 seconds.

The test element is scanned in a spatially resolved manner by at least one light source. In this process, different sections of the test element are sequentially illuminated in the case of a system of the second type, or different sections of the test element are detected in a system of the first type. If the test element is immobilized, the position and size of these sections can be exactly defined during the measurement by means of the coordinates of the at least one light source or of the at least one detector and the known radiation properties of the at least one light source. The sequentially irradiated surface area can be varied by selection of the at least one light source and of the illumination optics in the system of the second type. In a preferred embodiment, the illuminated section on the detection area is minimized by optimizing the distance of the light source together with the selection of the illumination optics. In addition to a sequential irradiation of the detection area of the test element, a fixed irradiation can also be carried out in which the test element is moved in a spatially resolved manner.

At least one light source which illuminates the detection area in as homogeneous a manner as possible is required for the illumination in a system of the first type in which the spatial resolution is achieved by the detector. This can, for example, take place by using a plurality of light sources. An alternative is to use a light source whose light is homogeneously scattered onto the detection area by a scattering unit (for example a milk glass). It is possible to use light sources that are known in the prior art.

Various illumination systems can be used in a system of the second type to sequentially illuminate the test element. These, for example, include a simple laser diode combined with a reflector which can be adjusted by micromechanics. The light beam can be focused without gaps onto various subareas of the detection area of the test element with the aid of the reflector. An unbroken illumination and/or detection of the detection area is also referred to as scanning. Alternatively, a laser array can be used such as a VCSEL-array (vertical cavity surface emitting laser). In this case each laser in the array can be addressed individually. The VCSEL offers the advantage that the light diverges less. These laser structures have a radiation divergency of about 5-8°. In this manner it is not only possible to irradiate a small surface area, but the amount of light on this area is very high as well. The laser is moved very close to the detection area of the test element (e.g. a few centimetres) and it is possible to omit an imaging unit such as lenses or diaphragms.

Another possibility is a laser diode array. In this case, the light can either be coupled into an image guide which guides the excitation light to the test element, or the light is instead focused onto the various areas of the test element by means of a microlens array which is arranged between the LED array and the test element. An OLED chess board (organic light emitting diodes) can also be used as a further illumination unit. In this case an illumination LED and a detector are arranged directly adjacent to one another. By arranging several such illumination/detector units, it is possible to two-dimensionally or sequentially illuminate a large area and detect the reflection. Since the illumination and the detection are arranged at a similar angle to the test element, this arrangement is preferably suitable for fluorescence measurements since in this case the excitation light and the light emitted from the detection area can be easily separated from one another by means of filters.

Systems of the second type have the advantage that they are insensitive to ambient light and can additionally homogeneously illuminate the detection area. In the case of only one light source, this can only be carried out with additional constructional elements. Furthermore, the energy input and thus the amount of light on the detection area is higher than with an illumination with only one light source, which can result in a more sensitive measurement.

The illumination unit of the first as well as of the second type can consist of a monochromic or multispectral, coherent or incoherent radiation source. The radiation from the illumination unit is used to penetrate into the detection area in order to measure the analyte directly or to measure the color reaction of a reagent with the analyte. The illumination unit preferably consists of one or more LEDs, the light of which either ensures a specially selected spatial intensity distribution in the detection area or ensures a homogeneous illumination. The excitation can be focused in order to obtain depth information. The focus is then shifted in the direction of the depth dimension. Excitation can, optionally, be by means of a multispectral LED array. A coherent excitation using laser diodes, for example, in the blue/ultraviolet spectral range is conceivable, especially in fluorimetry. In a preferred embodiment, light at a wavelength of 600 nm is detected.

At least one imaging unit can be incorporated between the illumination unit and the detection area. This imaging unit can be composed of imaging optical elements such as lenses, mirrors, prisms, light-conducting, scattering or holographic elements. This ensures that the detection area is irradiated as homogeneously as possible as is suitable especially for systems of the first type. A further imaging unit is used to project the irradiated sample body onto the detection unit. This imaging unit also consists of imaging optical elements such as lenses, mirrors, prisms, light-conducting, scattering or holographic elements. Optionally a microoptical lens array in which each individual element images delimited spatial areas of the test element onto individual elements of the detection unit can be used in an illumination unit of the second type.

The detection unit can consist of a two-dimensional or linear element which enables a spatially resolved as well as a time-resolved measurement of the scattered radiation that is emitted from the detection area. This element is preferably a two-dimensional CMOS array, a CCD array or a linear diode array in which a spatially resolved image of the detection area is formed by means of a scanning process. When using an illumination unit of the second type, a simple photodiode without spatial resolution may be sufficient. The detection unit converts the detected light intensity into electrical signals which are processed further by the evaluation unit.

Depending on whether the emitted light is detected by reflection or by transmission of the irradiated light, the detection unit is arranged on the same side or on the opposite side as the light source relative to the test element.

In order to not have to scan the complete detection area, it is possible to first illuminate individual subareas starting in the middle of the detection area in a coarse grid towards the outside. The first threshold value is used to determine whether it is a wetted or unwetted subarea. Signals from these subareas are used to make a first estimation of the position of the core area. The core area is illuminated in a narrower grid up to the edge areas. The illumination and evaluation can be terminated when a sufficient number of homogeneously wetted subareas have been measured. If an adequate number of subareas of the core area are not present, then it is possible to use subareas of the edge area for the evaluation which are evaluated with a correction algorithm. Alternatively, it is possible to average the evaluated areas from the core area and the edge area or only to evaluate the core area or the edge area. If the intensities from both areas are used, another possibility is to weight intensities from one of the two areas higher than the other, e.g., to give the core area a higher weight than the edge area or vice versa.

The evaluation unit processes the data from the detection unit. In this process, the analyte concentration in the sample volume is calculated as the main information. For this purpose, all algorithms that are required to determine the analyte in the homogeneous area but also in the edge area are stored in the evaluation unit. In addition, further information can be obtained such as the position, size and geometry of the sample drop. A pattern recognition process which is based on a spatially-dependent change in the detected light intensity is used for this.

This form of signal processing has the following advantages:

### 1. It enables the evaluation of small sample volumes of less than 1 μl since the position of the sample on the test element can be determined by the pattern recognition.

### 2. The method enables an underdosing to be detected from the geometry of the sample spot or detection of the filling state in a sample chamber.

3. It is possible to carry out an edge detection and use a correction algorithm for edge effects. This enables particularly small blood volumes (e.g., <50 nl) to be measured.
4. The edge detection additionally allows a determination of whether the flow properties of the sample are in the normal range. If they are not, it is possible to use at least two further correction algorithms for the evaluation which take into account an elevated or reduced viscosity of the sample.

### 5. The method allows the use of simple and cost-effective test elements.

6. If a spreading net (mesh layer) is used on the test element, the sample volume can be determined from the spot geometry. Knowledge of this parameter can be used to more exactly evaluate the measurement data.

The spatial (or two-dimensional) resolution in the detection system allows several parameters to be determined simultaneously. For this purpose the detection area is divided into spatially delimited areas. These delimited areas on the detection area carry reagents which, depending on the parameter, generate different reactions in which light is generated in different spectral ranges. A pattern recognition process enables these spatially delimited areas to be separated and subsequently analysed. This can be achieved by using a multispectral diode array. The embodiment of the “OLED detector chess board” from FIG. 5 is a possible realization of this variant.

Even in the case of the common two-dimensional test elements such as the commercial photometric glucose test strip, it is possible to obtain information about their state before sample application and during the detection reaction not only from the two surface dimensions but also from the volume dimension.

These teachings also concern a system for detecting small volumes of blood. This system preferably consists of a housing having at least one opening. The housing is able to receive or hold a test element. This can be by means of a holder on the outer side of the housing or the test element is inserted into the housing. A detection unit and an illumination unit are located in the housing. There may also be an evaluation unit in the housing. The test element is placed in such a manner that the detection area is always arranged at a known angle to the illumination or detection unit. The system preferably uses sensors to detect whether the test element has been correctly inserted into the holder. Furthermore, the system can have a mounting for the test element to ensure that the test element has been correctly inserted and is not moved during the measurement. After the optical signals have been evaluated the system can show the user the calculated analyte value by means of a display. The system can additionally comprise a warning system which indicates or signals to the patient when an incorrect measurement is present.

Further details and advantages of embodiments incorporating the present invention are explained hereafter on the basis of an exemplary embodiment with reference to the attached figures. The illustrated features can be used individually or in combination in accordance with these teachings.

### BRIEF DESCRIPTION OF THE DRAWINGS

The above-mentioned aspects of the present invention and the manner of obtaining them will become more apparent and the invention itself will be better understood by reference to the following description of the embodiments of the invention, taken in conjunction with the accompanying drawings, wherein:

FIG. 1a is a schematic representation of a sample drop on a detection area;

FIG. 1b is a schematic representation of a sample drop on a detection area with a discontinuous edge area;

FIG. 1c is a schematic structure of an illumination and detection system comprising at least one light source;

FIG. 1d is a schematic structure of an illumination and detection system for a test element having micromechanics for a reflector;

FIG. 2a is a schematic structure of a detection system with a laser array for the sequential illumination of the test element and a detector;

FIG. 2b is a schematic structure of the detection system of FIG. 2a in a top-view;

FIG. 3 is a schematic representation of a detection system comprising an LED array as an illumination unit of an image guide for guiding light onto a support foil and a light guide for collecting the reflected light onto the detector;

FIG. 4 is a schematic representation of an illumination or detection system with an LED array as an illumination unit of a microlens array for focusing the light onto areas of the test element and a detector;

FIG. 5 is a schematic representation of an OLED chess board which is used for illumination as well as to detect the reflected light;

FIG. 6 shows an example of a measuring instrument with an inserted test element;

FIG. 7 is a flowchart of a measuring scheme which is run by the evaluation unit;

FIG. 8a shows a liquid drop as it spreads on a coarse spreading net.

FIG. 8b shows a liquid drop as it spreads on a fine meshed spreading net.

Corresponding reference numerals are used to indicate corresponding parts throughout the several views.

### DETAILED DESCRIPTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

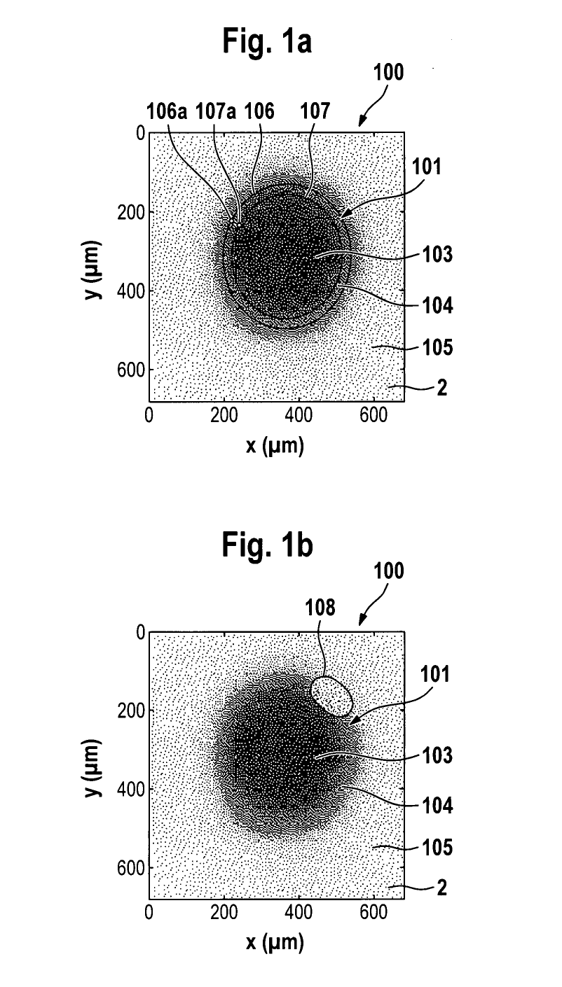

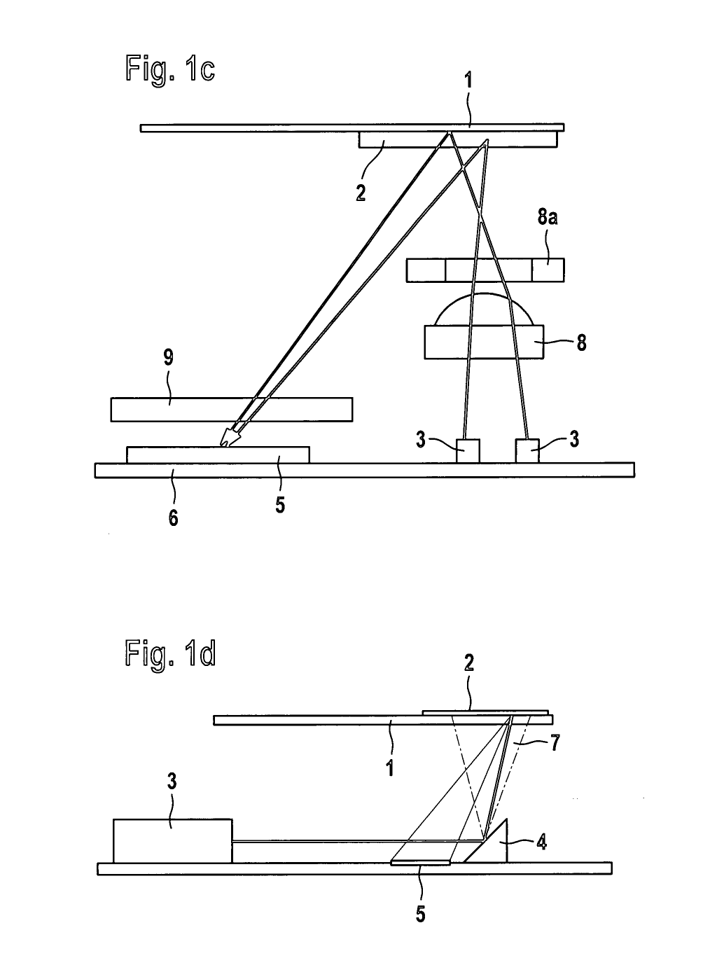

FIG. 1a shows an image 100 of a possible shape or contour of a sample drop 101 on a detection area 2. Three areas may be differentiated from one another. The core 103 of the drop is the darkest area in the image. On the outside the core is adjoined by the edge area 104. This edge area is characterized by a slight lightening compared to the core. The non-wetted subareas 105 which are almost white, i.e., represent the lightest area on the detection area 2, are located around the edge area 104. The circles 106 and 107 schematically represent the two threshold values used to delimit the three areas. Edge area 104 is delimited from the core area 103 by the circle 107. The edge area 104 is additionally delimited from the unwetted area 105 by the circle 106. The distances between the points on the circle 106 (representing the first threshold value) and the points on the circle 107 (representing the second threshold value) are determined in order to establish the thickness of the edge area 104. This is shown as an example by the two points 106a and 107a.

FIG. 1b shows a schematic image 100 of a sample drop 101 which exhibits a non-uniform spreading on a detection area 2. The circle 108 indicates that there is a discontinuity at one point on the edge area 104. This discontinuity can have various causes, as already described. The most frequent cause for such a discontinuity of the edge area 104 is a contamination of the detection area 2. If the size of this discontinuity exceeds a certain threshold value, the measurement can be terminated since there is a risk that the results of this measurement do not provide an accurate determination of the analyte.

As already mentioned, the system comprises instruments to detect concentrations of at least one analyte in a body fluid on a test element. In this connection, the system ensures the detection of very small sample volumes (e.g., 10 nl−1 μl). FIG. 1c shows a schematic layout of such a system. The test element 1 is irradiated from the side opposite to that of the detection area 2 by means of at least one light source 3. The reflected light is captured with the aid of a detection unit 5. The light source 3 and the test element 1 are preferably arranged at an angle of 90°. This ensures an optimal illumination of the test element. However, the angle can be other than 90° depending on the properties or geometry of the light source. The detection unit 5 should be arranged at an angle between 10 and 80° between the test element 1 and detection unit 5 in order to collect the emitted light. It is preferable to detect at an angle of 45° to the test element 1. This minimizes the effects of the irradiated light. The imaging units such as lens 8, diaphragm 8a and filter 9 are optional. At least one additional imaging unit 8, 8a and 9 can be inserted between the illumination unit and the test element as well as between the test element and the detection unit in order to improve the light yield. The imaging units 8 and 8a are used to focus the radiation from the light source 3 onto the sample site whereas the imaging unit 9 is used to filter and/or collect light emitted from the test element 1 onto the detection unit 5. The various imaging units consist of a combination of imaging optical elements such as lenses, diaphragms, filters (grey filters, polarization filters etc.), mirrors, prisms, light-guiding or holographic elements. The imaging units 8, 8a and 9 are optional and can be used in all possible combinations of the optical elements. In FIG. 1d a test element 1 is shown with the corresponding detection area 2 which is illuminated by laser diode 3 from the side opposite to that of the detection area. The light from the laser diode 3 is guided onto the test element 1 by a reflector 4 whose position can be adjusted by means of micromechanics. Part of the light is reflected by the test element and collected by a detector 5. The laser diode 3 and the reflector 4 can be mounted on a support element 6. The light which impinges on the reflector 4 is emitted again at an angle between 10° and 170° and preferably at an angle of 70° to 110°. The reflector 4 can be actuated in such a manner that the complete detection area 2 is sequentially scanned with a small grid spacing. The area that is irradiated and detected in this manner is referred to as the scan area 7 of the system. Thus a grid of from 1×1 up to 640×480 pixels or more can be achieved on a test element 1 with a detection area 2 having a size of a few square millimetres.

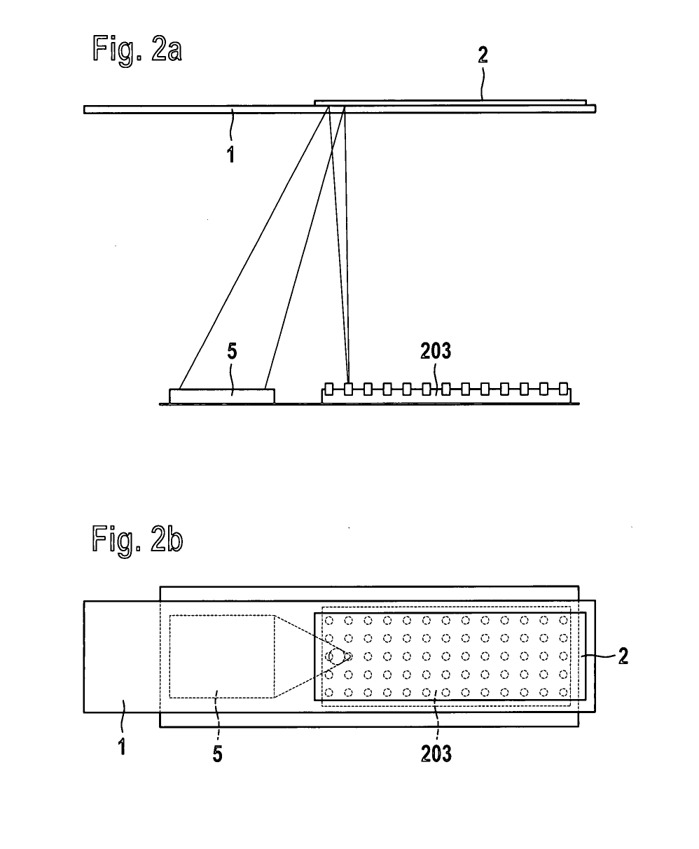

As shown in FIGS. 2a and 2b, this scanning can, for example, be achieved by a laser array 203 (e.g., an array with several VCSELs). In this connection, it is possible to use arrays in the form of 2×2, 4×4, 8×8 or 16×16 lasers or a multiple thereof. Also in this case the detection area 2 is irradiated through the test element 1. This can prevent components of the sample which are retained in various layers of the test element from interfering with the measurement. The individual lasers 203 are actuated sequentially to carry out a spatially resolved measurement of the detection area 2. In this arrangement, the detector 5 does not have to be able to detect in a spatially resolved manner.

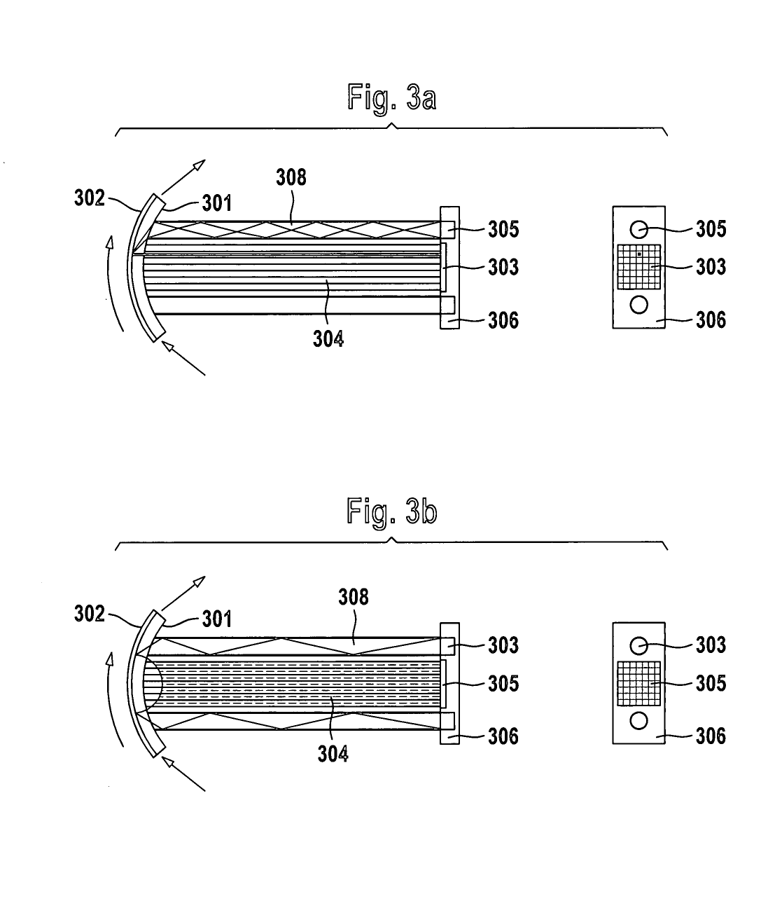

In a further embodiment which is shown in FIG. 3a, an LED array 303 is used which guides light that is focused by an image guide 304 onto the test element which is in this case a flexible support foil 301 with a detection area 302. In this case the support foil can be curved which requires a homogeneous illumination of the detection area 302. The image guide 304 can in this case be an array or a bundle of glass or polymer fibres. The light reflected from the test element 301 is guided to the detector 305 using a light guide 308. The LED array 303 is in this case also arranged in formats of 2×2, 4×4, 8×8, 16×16 or more LEDs. The excitation unit 303 and the detection unit 305 can be mounted on a support element 306. One variant of this embodiment is shown in FIG. 3b. In this case, the function of the image guide 304 and the light guide 308 are interchanged. As a result, the arrangement of the light source 303 and the detection unit 305 are also interchanged.

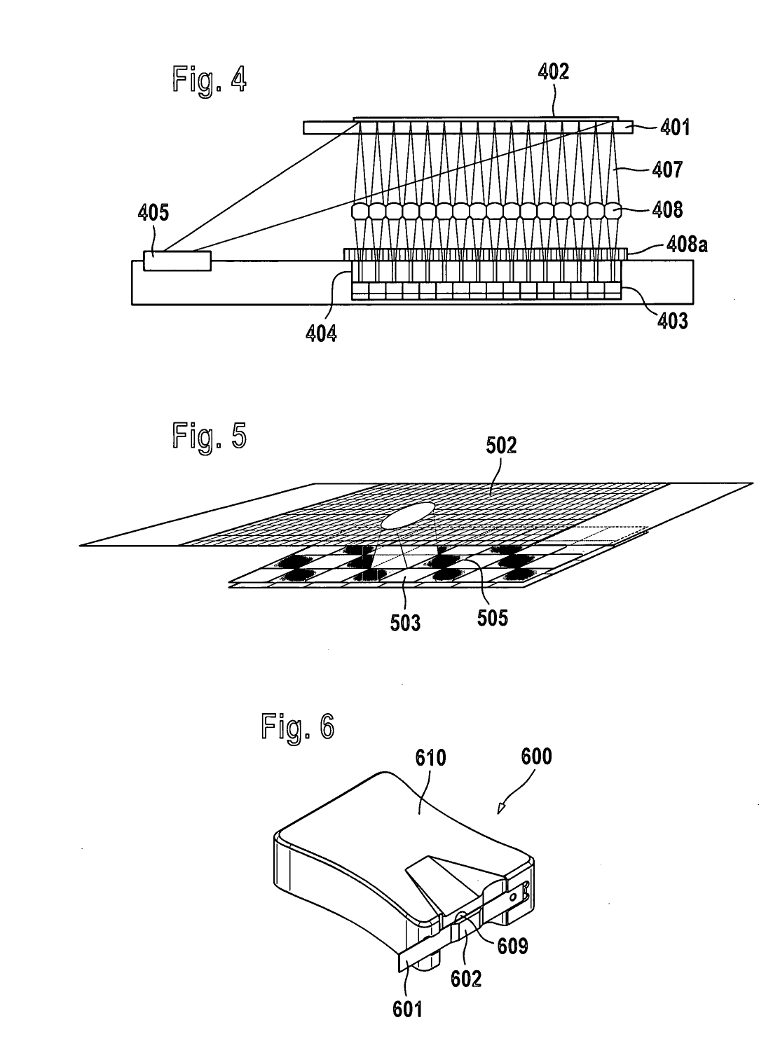

Another embodiment is shown in FIG. 4 which also uses an LED array 403, the light of which is bundled in one direction by means of a microaperture array 404. The light of each individual LED from the LED array 403 is focused onto the detection area 402 of the test element 401 with the aid of a microlens array 408 and, optionally, an aperture arrangement 408a. The microlens array 408 has the same dimensions as the LED array 403 so that each LED is provided with a microlens. Each LED on the array can be addressed individually and has its own path of rays 407. This addressing capability enables the test element surface to be scanned since the position of each individual LED is known. The light that is reflected from the test element is collected by means of a detector 405.

FIG. 5 shows a space-saving solution. An OLED detector 505 is used to sequentially illuminate the test element. In this case each light emitting electrode 503 is arranged next to a small detector 505 as on a chess board. This allows the illumination unit 503 together with the detection unit 505 to be located very near to the detection area 502 of the test element. As a result, very little scattered light is formed by the LED, and a high spatial resolution can be ensured. In an exemplary embodiment, the pixel size of the OLED fields is between 50 and 100 nm.

FIG. 6 shows an example of a measuring instrument 600 with a housing 610 which has a holder on one side for the test element 601. The detection area 602 on the test element 601 is directly in front of an opening 609 when the test element 601 is completely inserted. The opening 609 is used to directly guide the excitation light from the light source, which is located inside the housing 610, onto the test element 601. As shown in FIG. 6, the detection area 602 is readily accessible to the patient. Consequently, it is simple for the patient to apply the sample and the risk of contaminating the housing 610 is very small.

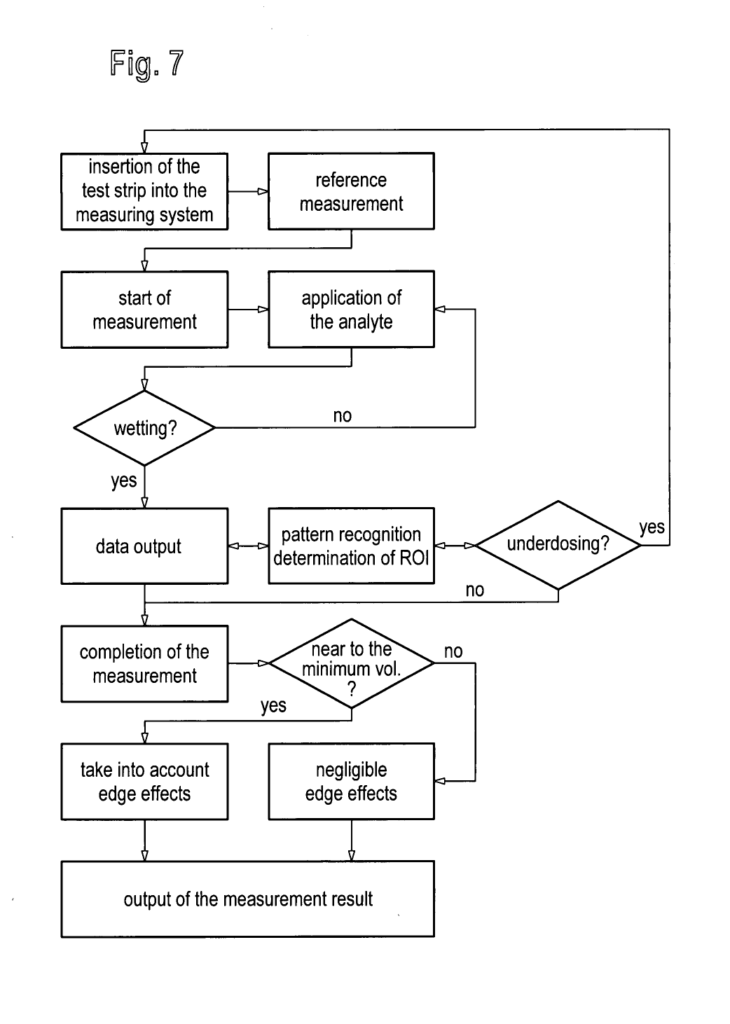

FIG. 7 shows schematically how a measuring process is carried out. The test element is inserted into the measuring system as the first step. After it has been correctly inserted into the system, a reference measurement takes place, whereupon the actual measurement is started by applying the analyte to the detection area. Afterwards, the wetting of the test element is automatically checked. If the system has calculated an inadequate wetting, it prompts the patient to apply more sample, whereas if the wetting is adequate, the system proceeds with the pattern recognition and determination of the region to be evaluated (region of interest ROI). Despite an adequate wetting, the system can carry out another correction at this point if an underdosing has been found. The consequence of an underdosing is that another test strip has to be used. When the dosage is correct, the dosing measurement is terminated and the system determines whether edge areas have to be used to calculate the analyte concentration or not. The system then proceeds automatically with the calculation and subsequently outputs the result of the measurement.

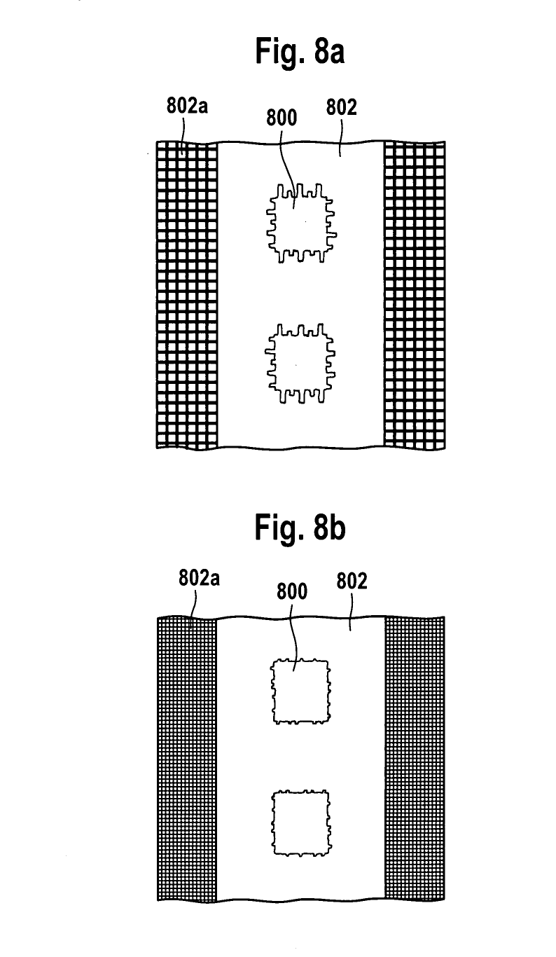

Two different detection areas 802 are shown in FIGS. 8a and b which show different spreading behavior. A detection area 802 with a very coarse spreading net 802a is shown in FIG. 8a. As a result the applied liquid drop 800 spreads very irregularly on the detection area 802. A considerably more fine-meshed net 802a is incorporated into the detection area 802 in FIG. 8b. Here it can be seen that the liquid spreads much more uniformly on the detection area 802.

While exemplary embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A diagnostic instrument for testing sample fluids, comprising:
an illumination unit having at least one light source and configured to illuminate a plurality of subareas of a detection area of a test element;
a detection unit configured to detect the light emitted from the subareas; and
an evaluation unit in communication with the detection unit and configured to determine presence or concentration of an analyte in a sample applied to the detection area of the test element as a function of the light detected from the subareas, wherein the evaluation unit compares the light detected from at least a portion of the subareas with first and second threshold values and allocates at least a portion of the subareas to an edge area on the basis of the comparison.

2. The instrument of claim 1, wherein the evaluation unit uses the edge area for a quality control.

3. The instrument of claim 2, wherein the quality control comprises determining the viscosity of the sample.

4. The instrument of claim 2, wherein the quality control comprises determining the hematocrit content of the sample.

5. The instrument of claim 1, wherein the instrument is configured to receive a test element containing a reagent which is substantially homogeneously distributed in or on the detection area.

6. The instrument of claim 1, wherein the evaluation unit is configured to spatially resolve the light intensities of the subareas and associate the measured light intensity values from each subarea with the position coordinates of the corresponding subarea.

7. The instrument of claim 1, wherein the evaluation unit is configured to determine the surface area of the edge area as a function of the number of subareas whose light intensities are determined by the evaluation unit to lie between the first and the second threshold values and the known surface area of the subareas.

8. The instrument of claim 7, wherein the measurement of the analyte is terminated when the surface area of the edge determined by the evaluation unit fails to meet a defined proportion.

9. The instrument of claim 7, wherein the measurement of the analyte is terminated when the number of subareas determined by the evaluation unit to meet the first and the second threshold values and also directly adjoin unwetted subareas exceeds a maximum value.

10. The instrument of claim 1, wherein the evaluation unit characterizes subareas failing to meet both the first and second threshold values as unwetted subareas, subareas meeting the first and failing the second threshold values as edge subareas, and subareas meeting both the first and second threshold values as core subareas.

11. The instrument of claim 10, wherein the evaluation unit determines the distance to the nearest unwetted subarea for each core subarea that adjoins at least one of the edge subareas.

12. The instrument of claim 11, wherein the measurement is terminated when a certain number of the determined distances falls below a minimum edge width threshold value.

13. The instrument of claim 10, wherein the evaluation unit determines the distance to the furthest removed unwetted subarea for each core subarea that adjoins one of the edge subareas, wherein the distance is determined by measuring only along paths in which edge subareas are positioned between the core and the unwetted subareas, and wherein the measurement is terminated when the distance exceeds a maximum edge width threshold value.

14. The instrument of claim 10, wherein the core subareas are evaluated using a first algorithm and the edge subareas are evaluated with a correction algorithm.

15. The instrument of claim 10, wherein a curve is determined of edge subareas which lie on the shortest path between unwetted subareas that are adjacent the edge area and core subareas that are adjacent the edge area.

16. The instrument of claim 15, wherein the evaluation unit is configured to use the curve for quality control.

17. The instrument of claim 1, wherein the illumination unit is controllable such that at least one light source of the illumination unit illuminates a defined section on the detection area.

18. The instrument of claim 1, wherein the illumination unit is configured to sequentially illuminate different sections on the detection area.

19. The instrument of claim 1, wherein the illumination unit comprises a semiconductor laser which emits a laser beam substantially perpendicular to a plane defined by the detection area.

20. The instrument of claim 1, wherein the evaluation unit is configured to evaluate sample volumes of less than 1 μl.

21. The instrument of claim 1, further comprising a scattering medium configured to homogeneously distribute the light of the light source onto the detection area of the test element.

22. A method of evaluating a test element having a detection area that produces a change in an optical property when a sample liquid is applied thereto, comprising:
dosing the test element with a liquid sample to form a sample drop on the detection area;
illuminating a plurality of subareas on the detection area;
detecting light emitted from the subareas;
evaluating whether the light detected from each subarea meets first and second threshold values; and
classifying subareas meeting the first and failing the second threshold values as edge subareas.

23. The method of claim 22, further comprising classifying subareas failing to meet both the first and second threshold values as unwetted subareas and subareas meeting both the first and second threshold values as core subareas.

24. The method of claim 23, further comprising determining the contour of an edge area of the sample drop from the edge subareas.

25. The method of claim 24, further comprising terminating the evaluation when the width of the edge area exceeds a maximum edge width threshold value.

26. The method of claim 24, further comprising terminating the evaluation when the width of the edge area is less than a minimum edge width threshold value.

27. The method of claim 23, further comprising quantifying the number of core subareas that directly adjoin unwetted areas.

28. The method of claim 27, further comprising terminating the measurement when the number of core subareas determined to adjoin unwetted areas exceeds a maximum value.

29. The method of claim 23, further comprising:
determining the distance to the furthest removed unwetted subarea for each core subarea that adjoins at least one of the edge subareas, wherein the distance is determined by measuring only along paths in which edge subareas are positioned between the core and the unwetted subareas; and
terminating the measurement when the distance exceeds a maximum edge-width threshold value.

30. The method of claim 23, further comprising evaluating the core subareas with a first algorithm and the edge subareas with a correction algorithm.

31. The method of claim 23, further comprising determining the shape of a core area of the sample drop from the core subareas.

32. The method of claim 31, further comprising identifying a discontinuity in the core area.

33. The method of claim 32, further comprising determining the size of the discontinuity and terminating the evaluation if the discontinuity exceeds a threshold size.

34. The method of claim 22, further comprising sequentially illuminating different subareas on the detection area.

35. The method of claim 22, wherein the illuminating a plurality of subareas on the detection area comprises homogeneously distributing light onto the detection area of the test element.

36. The method of claim 22, wherein the fluid sample has a volume less than 1 μl.

37. A method of evaluating a test element having a detection area that produces a change in an optical property when a liquid sample is applied thereto, comprising:
dosing the test element with a liquid sample to form a sample drop on the detection area;
illuminating a plurality of subareas on the detection area;
detecting light emitted from the subareas; and
determining the shape of the sample drop relative to the detection area.

38. The method of claim 37, further comprising determining an edge area of the sample drop.

39. The method of claim 37, further comprising identifying a discontinuity in the sample drop.

40. The method of claim 37, wherein the shape determined of the sample drop is irregular.

41. The method of claim 37, further comprising evaluating whether the light detected from each subarea meets first and second threshold values and classifying subareas meeting the first and failing the second threshold values as edge subareas.

42. The method of claim 41, further comprising classifying subareas failing to meet both the first and second threshold values as unwetted subareas and subareas meeting both the first and second threshold values as core subareas.

43. The method of claim 42, further comprising determining the shape of an edge area of the sample drop from the edge subareas.

44. The method of claim 43, further comprising terminating the evaluation when the width of the edge area exceeds a maximum edge width threshold value.

45. The method of claim 43, further comprising terminating the evaluation when the width of the edge area is less than a minimum edge width threshold value.

46. The method of claim 42, further comprising evaluating the core subareas with a first algorithm and evaluating the edge subareas with a correction algorithm.
